(19) United States
(12) Patent Application Publication
(10) Pub. No.: US 2004/0116128 A1
(43) Pub. Date: Jun. 17, 2004

(54) Method for making inquiry about cellular phone user's location

(75) Inventor: James Chen, Hsinchu (TW)

Correspondence Address: BACON & THOMAS, PLLC, 625 SLATERS LANE, FOURTH FLOOR, ALEXANDRIA, VA, 22314

(73) Assignee: LITE-ON TECHNOLOGY CORPORATION, Taipei (TW)

(21) Appl. No.: 10/445,921

(22) Filed: May 28, 2003

(30) Foreign Application Priority Data
Dec. 13, 2002 (TW) 091136201

(51) Int. Cl. H04Q 7/20

(52) U.S. Cl. 455/456.1; 455/456.3

(57) ABSTRACT

A cellular phone is used to transmit a short message preset by a cellular base station through an Unstructured Supplementary Service Data (USSD) function to activate or stop accepting a function for making inquiry about the position of a cellular phone user. A user of another cellular phone sends a USSD brevity code to the base station to inquire where is the cellular phone user now; the inquiry is refused if the position inquiry acceptation is stopped. If the position inquiry acceptation is activated, the base station uses a positioning technology to calculate a position coordinate of the inquired cellular phone user. And then, the base station compares the position coordinates with a location data in a position coordinate database stored in a computer of the base station and transfers the location to a closest address and then to inform the inquirer by a short message.

### BACKGROUND OF THE INVENTION

1. Field of the Invention

The present invention relates to a method for making an inquiry about a cellular phone user's location, and more particularly to a method for a cellular phone user (inquirer) to inquire on a location of another cellular user through a Unstructured Supplementary Service Data (USSD) function and the location is transmitted back to a screen of the inquirer's cellular phone.

2. Description of Related Art

An oral communication must be used for a person to inquire about another person's location through a cellular phone, even if the development of the cellular phone is prosper today. Therefore, the inquired party is interrupted at some places or occasions such as sleeping, car driving, working or going abroad.

### SUMMARY OF THE INVENTION

The main object of the present invention is to provide a method for making an inquiry about a cellular phone user's location, an Unstructured Supplementary Service Data function is used for a cellular phone user (inquirer) to inquire another cellular phone user's location (inquired party), enabling the inquirer to known easily and conveniently where the inquired party is now without going through an oral communication.

Another object of the present invention is to provide a method for making an inquiry about a cellular phone user's location; it can prevent an inquired party from being interrupted at some places or occasions because an oral answering is not more needed.

Another object of the present invention is to provide a method for making an inquiry about a location of a cellular phone user, that an inquirer inquires a location of an inquired party not only can attain a tracking effect, but also reach a safety requirement.

Another object of the present invention is to provide a method for making an inquiry about a cellular phone user's location; the method can be applied to any cellular phone with USSD function; there is no need to develop a cellular phone with new functions so as to prevent resources from wasting.

### BRIEF DESCRIPTION OF THE DRAWINGS

The present invention can be more fully understood by reference to the following description and accompanying drawings, in which:

FIG. 1 is a schematic view of a preferred embodiment according to the present invention, showing a cellular network system having a positioning function and equipped with a location coordinate database;

FIG. 2 is a flow chart, showing an operation for activating or stopping a position inquiry function;

FIG. 2A shows some pictures of a screen of a cellular phone corresponding to some specific steps shown in FIG. 2;

FIG. 3 is flow chart, showing an operation for inquiring a cellular phone user current location according to the present invention,

FIG. 3A shows some pictures of a screen of a cellular phone corresponding to some specific steps shown in FIG. 3.

### DETAILED DESCRIPTION OF THE PREFERRED EMBODIMENTS

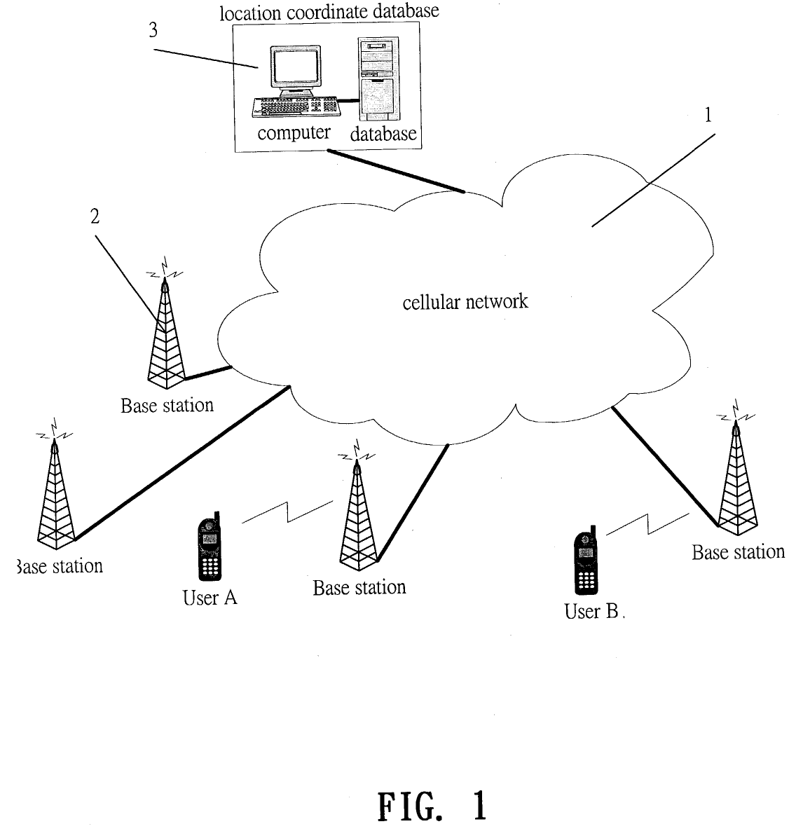

First, please refer to FIG. 1. FIG. 1 is a schematic view of a preferred embodiment according to the present invention, showing a cellular network system having a positioning function and being equipped with a location coordinate database. When a cellular phone user B wants to known the location of a cellular phone user A, the cellular phone user B sends out a brevity code preset by a cellular base station to a cellular base station 2 through cellular network 1. The base station check whether the cellular phone user accepts a location inquiry on him after the base station receives the brevity code. If yes, the base station uses a current positioning technology, such as Global Positioning System (GPS) , Triangular Positioning Technology or Base Station Positioning Technology, to calculate the position coordinates of the cellular phone user A. Thereafter, the base station 2 compares the position coordinates with data in a location coordinate database 3 and converts the position coordinates to a closest address. And then, the base station sends out the address to a cellular phone of the cellular phone user B's.

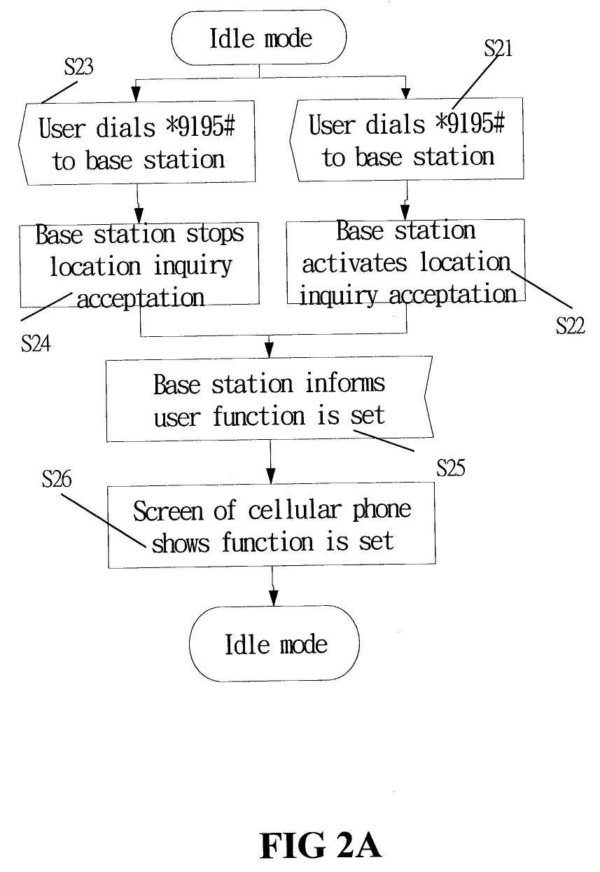

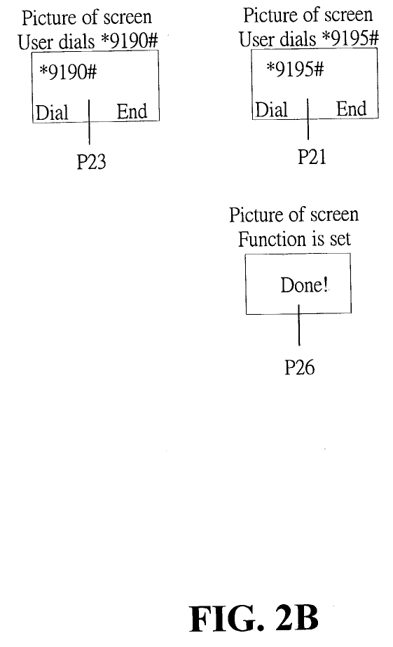

Next, please refer to FIG. 2A and 2B. FIG. 2A and 2B are a flow chart and pictures of a screen of a cellular phone corresponding to some specific steps, showing an operation for activating or stopping a position inquiry function. A cellular phone user sent out an USSD brevity code (“*9195#” and “*9190#” are represented as activating and stopping a location inquiry respectively) preset by a base station to activate or stop a function of a location inquiry on him. If the cellular phone user sent out the USSD brevity code “*9195#” to a base station to show his will to accept the location inquiry from other cellular phone user (step S21), the base station activates a function for accepting the location inquiry (step S22). Vice versa, if the cellular phone user sends out the USSD brevity code “*9190#” to the base station to refuse the location inquiry on him (step S23; picture P23), the base station stops the function for accepting the location inquiry (step S24). In either case mentioned above, the base station will inform the user the function setting is completed (step S25). At the same time, the function completion is shown on the screen of the user's cellular phone (step S26; picture P26).

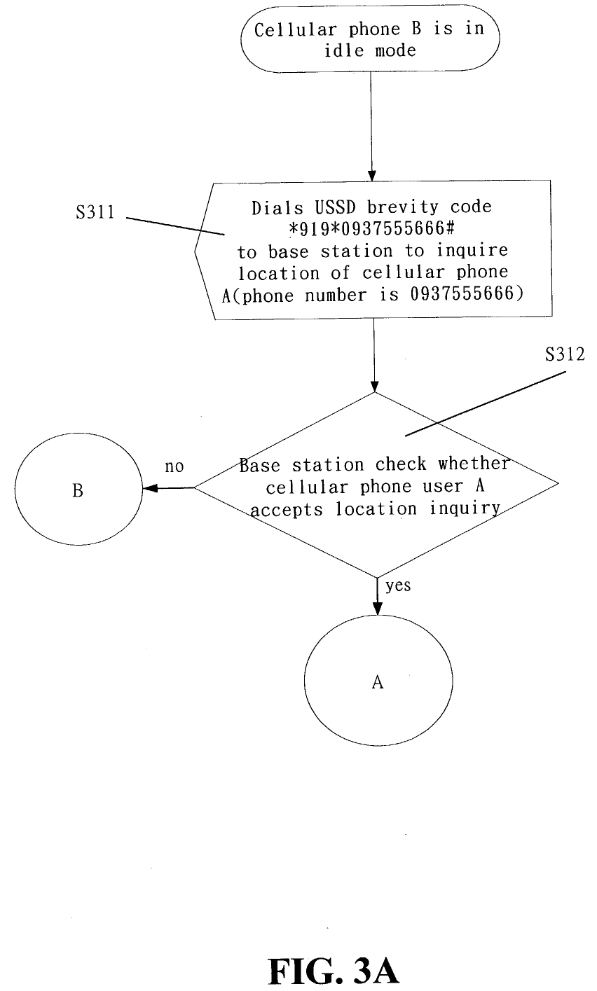

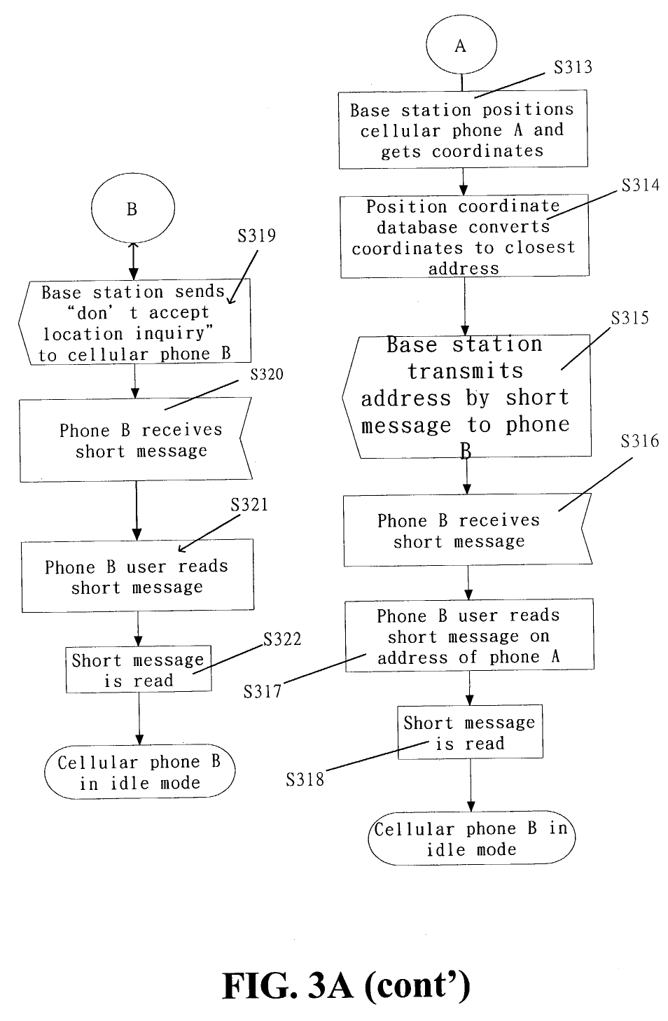

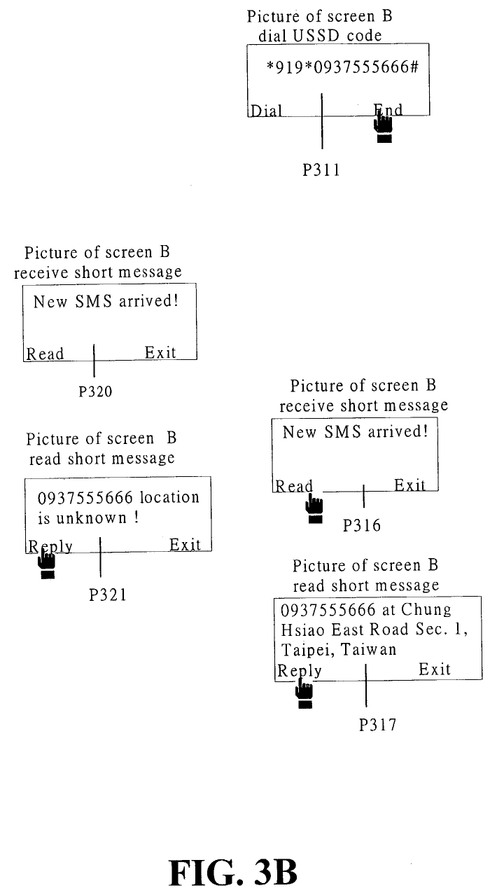

Finally, please refer to FIG. 3A and 3B. FIG. 3A and 3B are a flow chart and pictures of a screen of a cellular phone corresponding to some specific steps, showing an operation for inquiring a cellular phone user current location. First, a cellular phone user B's phone is in an idle mode, the user B (inquirer) sends out an USSD brevity code (*919*0937555666# is assumed here) to inquire the current location of a cellular phone user A (inquired party; the telephone number is 0937555666)(step S311; picture P311). The base station checks whether the user A accepts the location inquiry after receives the brevity code (step S312). If yes, the base station positions the user A and gets his coordinates (step S313). The coordinates are converted to a closest address through a location coordinate database (step S314). Thereafter, the base station sends the address to the user B's phone by a short message (step S315). At the same time, the user B's phone receives the short message of the address of the user A (step S316; picture P316). The user B can operate the cellular phone to read the short message of the address after receiving the message (step S317; picture P317). The cellular phone is back to idle mode after the message is read (step S318). If it is no in the step S312, the base station sends out a short message “the location inquiry is not allowed” to the user B's phone (step S319). At the same time, the user B's phone receives the short message, which is shown on the screen of the phone (step S320; picture P320). Thereafter, the user B can read the message from his telephone (step S321; picture P321). The user B's phone is back to the idle mode after the message is read (step S322).

It is noted that the method for making an inquiry about a location of a cellular phone user described above is the preferred embodiment of the present invention for the purpose of illustration only, and are not intended as a definition of the limits and scope of the invention disclosed. Any modifications and variations that may be apparent to a person skilled in the art are intended to be included within the scope of the present invention.

1. A method for making an inquiry about a cellular phone user's location, used for a cellular phone user B to inquire a location of another cellular phone user A, mainly comprising the following steps:
(1) said user B sending out a USSD brevity code to a cellular base station to inquire said user A's current location;
(2) said base station using a positioning technology to calculate said user A's coordinates;
(3)said base station comparing said user A's coordinates with a coordinate position stored in a location coordinate data base belonging to said base station and converting said coordinates to a closed address; and
(4) said base station sending a short message back to said user B's cellular phone.

2. The method according to claim 1, wherein if said user A sends out a brevity code preset by said base station to activate a location inquiry acceptation, said short message comprises said address.

3. The method according to claim 1, wherein if said user A sends out a brevity code preset by said base station to stop a location inquiry acceptation, said step (2) and (3) are skipped and said step (4) is directly processed after said step (1) is completed.

4. The method according to claim 3, wherein said short message is “Location inquiry is not allowed”.

5. The method according to claim 1, wherein said positioning technology is Global Positioning System (GPS), Triangular Positioning Technology or Base Station Positioning Technology.

6. A method for making an inquiry about a cellular phone user's, used for a cellular phone user B to inquire a location of another cellular phone user A, mainly comprising the follow steps:
(1) a cellular phone user A sending a USSD brevity code preset by a base station to activate or stop a location inquiry acceptation on him;
(2) a cellular phone user B sending another USSD brevity code preset by said base station to inquire where is the location of said user A, if said location inquiry acceptation is stopped, directly going to process the following step (5), otherwise;
(3) said base station using a positioning technology to calculate said user A's current position;
(4)said base station comparing said user A's coordinates with a coordinate position stored in a location coordinate database belonging to said base station and converting said coordinates to a closed address; and
(5) said base station sending a short message back to said user B's cellular phone, if said user A sends out said brevity code preset by said base station to activate a location inquiry acceptation, said short message comprising said address, if said user A sends out said brevity code preset by said base station to stop a location inquiry acceptation, said short message being “Location inquiry is not allowed”.

7. The method according to claim 1, wherein said positioning technology is Global Positioning System (GPS), Triangular Positioning Technology or Base Station Positioning Technology.
